(19) United States
(12) Patent Application Publication
(10) Pub. No.: US 2026/0117478 A1
(43) Pub. Date: Apr. 30, 2026

(54) SYSTEMS AND METHODS FOR COLLECTING MARINE AND FRESHWATER DEBRIS USING DRONES

(71) Applicant: GLOBALKOREA CO., LTD., Andong-si (KR)

(72) Inventor: Jinho SONG, Andong-si (KR)

(73) Assignee: GLOBALKOREA CO., LTD., Andong-si (KR)

(21) Appl. No.: 19/325,408

(22) Filed: Sep. 10, 2025

(30) Foreign Application Priority Data
Oct. 30, 2024 (KR) 10-2024-0150542

(51) Int. Cl. E02B 15/10; B63B 35/32; B64U 20/80; B64U 50/37; B64U 70/93; B64U 101/29; C02F 1/00; C02F 1/48; C02F 101/10; C02F 101/32; C02F 103/00; C02F 103/08; G05D 1/248; G05D 1/622; G05D 1/698; G05D 105/00; G05D 107/00; G05D 109/30

(52) U.S. Cl. CPC E02B 15/10; B64U 20/80; B64U 50/37; B64U 70/93; C02F 1/008; C02F 1/484; G05D 1/248; G05D 1/622; G05D 1/6985; B63B 35/32; B64U 2101/29; C02F 2101/10; C02F 2101/32; C02F 2103/007; C02F 2103/08; C02F 2209/006; G05D 2105/14; G05D 2107/27; G05D 2107/28; G05D 2109/34

(57) ABSTRACT

Disclosed is a marine and freshwater debris collection system using drones and a method for collecting debris using the same. More specifically, the invention allows for the faster and more efficient collection of debris in marine and freshwater environments through the use of drones. In particular, the drones approach a target point, launch a net, and a net hoisting and retrieval hook is used to hoist the trapped debris onto the vessel. This entire process is automated or semi-automated, thereby maximizing the efficiency of the debris collection operation.

### CROSS-REFERENCE TO RELATED APPLICATIONS

This application claims the benefit of Korean Patent Application No. 10-2024-0150542, filed on Oct. 30, 2024, the disclosure of which is incorporated herein by reference in its entirety.

### BACKGROUND

The accumulation of debris in marine and freshwater environments has escalated to a critical threshold, with millions of tons of debris entering the world's oceans annually. This phenomenon not only drives the degradation of marine ecosystems but also poses severe threats to marine biodiversity, human health, and socio-economic activities. Current technological approaches remain profoundly inadequate in addressing this global challenge. Conventional debris collection practices, which predominantly depend on large vessels or manual labor, are associated with substantial technical, economic, and environmental limitations.

The majority of conventional collection strategies rely heavily on large vessels and manual labor. Such vessels are required to operate over extended durations to recover marine debris, a process that entails substantial fuel consumption and imposes considerable environmental burdens. In addition, the manpower and specialized equipment necessary for vessel operation incur significant economic costs, while personnel involved in debris collection are routinely subjected to physically strenuous and hazardous working conditions.

For instance, conventional debris collection practices require extensive navigation by vessels across large spatial areas, followed by the physical retrieval of debris using nets or comparable apparatus. Such approaches are markedly inefficient, incapable of achieving comprehensive debris removal, and particularly ineffective in capturing small plastic fragments and microplastics. Moreover, these technologies are characterized by high labor intensity and impose substantial economic burdens.

Large vessels also have limitations in navigating narrow waterways, rocky areas, or environmentally sensitive regions. In particular, vessels demonstrate limited efficiency in collecting debris in coastal and nearshore regions. Restricted accessibility in coastal zones and narrow waterways facilitates the prolonged persistence of marine debris, thereby exacerbating the degradation of marine ecosystems.

Furthermore, extreme environmental conditions, such as storms and high waves, pose substantial risks of casualties. Current technologies lack reliable mechanisms for the safe collection of debris under such circumstances, thereby severely compromising worker safety.

In addition, conventional approaches are characterized by significant inefficiencies. Given that the collection of aquatic debris must encompass extensive spatial domains, vessel-based operations are intrinsically time-intensive and operationally inefficient. Substantial time is required for debris detection, and the process necessitates considerable fuel consumption, which not only exacerbates environmental pollution but may also exacerbate the accumulation of aquatic debris rather than alleviating it.

Moreover, the post-collection treatment of debris remains inefficient. Conventional systems typically accumulate the collected material onboard vessels and subsequently transport it to land for disposal. During this process, debris is frequently neither adequately sorted nor recycled but instead indiscriminately discarded, resulting in significant resource wastage. In particular, small particles such as microplastics are not effectively captured by conventional nets and therefore persist within the marine environment.

The financial burdens associated with marine debris collection using conventional technologies are substantial. Beyond the considerable costs of vessel maintenance and operation, labor, and fuel consumption, each collection campaign entails immense expenditures. Consequently, many countries deprioritize marine debris management, and due to limited budgets, marine pollution persists and continues to escalate.

Furthermore, the post-collection management of debris entails substantial financial and operational costs. Processes such as sorting, classification, and appropriate disposal of collected material are predominantly performed manually, demanding significant time and resources. Consequently, many countries are unable to sustain such expenditures, perpetuating a cycle in which marine debris continues to accumulate.

While conventional debris collection technologies are moderately effective at recovering large debris, they display substantial limitations in the capture of small particles, including microplastics. Microplastics are recognized as significant contributors to the disruption of marine ecosystems, yet existing technologies are largely ineffective in trapping these minute particles. This inefficacy arises in part because nets are typically designed with mesh sizes appropriate for larger debris, permitting smaller particles to escape and re-enter the marine environment.

In addition, marine debris is often entangled or widely dispersed, rendering retrieval with conventional tools highly challenging. Given its extensive spatial distribution, effective capture necessitates advanced technologies, which remain largely absent in conventional systems.

Conventional marine debris collection practices remain predominantly manual, with minimal integration of automation. Workers are required to physically deploy nets, capture debris, and retrieve it aboard the vessel. Such reliance on manual labor not only exacerbates worker fatigue during prolonged operations but also substantially diminishes overall efficiency. Moreover, in hazardous marine environments, these methods expose personnel to considerable risks of injury or fatality.

Marine debris pollution constitutes a global environmental challenge, necessitating the development of systematic and automated collection methodologies. However, existing technologies are inadequate in addressing these requirements, with the absence of automation representing a critical limitation of conventional approaches.

### SUMMARY

The present invention relates to a system and method for collecting debris in marine and freshwater environments using drones. More specifically, the invention provides a means for more rapid and efficient collection of debris by employing drones capable of navigating to a target location either aerially or underwater, deploying a net, and retrieving the captured debris onto a vessel. The collection process is fully or partially automated, thereby maximizing operational efficiency.

The present invention has been conceived to overcome the limitations of conventional debris collection methods. The primary objective of the invention is to provide a system that enables prompt and efficient resolution of debris accumulation in marine and freshwater environments. Conventional techniques rely on large vessels and manual labor, resulting in excessive fuel consumption, substantial labor requirements, and high operational costs. Moreover, these methods are limited in their ability to access narrow waterways, coastlines, or rocky areas that are difficult for vessels to reach. Small debris, including microplastics, is particularly challenging to collect, and operations conducted under extreme environmental conditions, such as storms, pose significant risks of human injury or fatality.

To address the foregoing issues, the present invention provides a system and method for collecting debris in marine and freshwater environments using drones, wherein the drones are configured to autonomously or semi-autonomously detect, capture, and retrieve debris of various sizes and types, and safely transport the collected debris to a vessel.

### BRIEF DESCRIPTION OF THE DRAWINGS

FIG. 1 is a schematic diagram illustrating the overall configuration of a marine and freshwater debris collection system employing an underwater drone according to an embodiment of the present invention.

FIG. 2 depicts a process in which an aerial drone deploys a net to trap debris at a target point according to an embodiment of the present invention.

FIG. 3 shows the overall configuration of the system according to an embodiment of the present invention.

FIG. 4 illustrates a process in which the integrated control system of the vessel controls the operation of drones and the net hauling and lifting hook according to an embodiment of the present invention.

FIG. 5 illustrates the structure of the net and the configuration of the net deployment device according to an embodiment of the present invention.

FIG. 6 illustrates the structure of the net hauling and lifting hook and its operation during debris retrieval according to an embodiment of the present invention.

FIG. 7 illustrates a process in which debris is treated onboard the vessel according to an embodiment of the present invention.

FIG. 8 illustrates a process in which the drones are recharged during autonomous movement according to an embodiment of the present invention.

### DETAILED DESCRIPTION

The present invention is hereinafter described in detail with reference to the accompanying drawings and specific embodiments.

Technical terms used in the present invention that correspond to the concept of the invention should be understood as being interchangeable with appropriate technical terms that would be recognized by those skilled in the art (e.g., ˜module, ˜server, ˜unit).

In describing the present invention, detailed explanations of well-known technologies that may obscure the gist of the invention are omitted. The accompanying drawings are provided solely to facilitate understanding of the present invention, and the scope of the invention should not be construed as being limited by the drawings.

One embodiment of the present invention provides a marine and freshwater debris collection system utilizing drones. The system comprises:

### (a) A Vessel (100):

The vessel is configured to serve as a mobile platform for debris collection operations and includes a drone launch and docking device that enables the launching recovery of drones. The vessel further comprises a communication module for real-time data exchange with the drones, a power supply device for charging drone batteries and supporting extended missions, and integrated communication and control units that allow remote operation or autonomous navigation. Through these components, the vessel can be maneuvered to designated target locations within marine or freshwater environments.

### (b) A Drone (210, 220):

The drone is an unmanned device deployed from the vessel, equipped with a camera and sensor module for detecting and accurately identifying debris at a target location. The drone further includes GPS and navigation systems to facilitate autonomous or semi-autonomous movement. In addition, the drone is equipped with obstacle detection and avoidance functions, utilizing sensor data from LiDAR, ultrasonic, or equivalent modules to follow a predefined route or adaptively adjust its trajectory. The drone is further configured to detect, capture, and collect debris present on the surface or underwater in marine and freshwater environments.

### (c) A Net (230):

The drone includes a mechanical or electrical driving mechanism capable of launching the net (230) at the target debris location.

The present invention further provides a debris collection method using drones in marine and freshwater environments, the method comprising:

### (a) Drone Launch Step:

After the vessel (100) arrives at or near a target point, drones (210, 220) are deployed. A communication link between the vessel's communication module and the drones is established to transmit information relating to the drone's movement path and the designated target point. The drones are launched from a drone launch and docking device mounted on the vessel and are navigated to the designated area by remote control or autonomous navigation.

### (b) Drone Movement Step:

The drones utilize GPS and navigation systems to set the coordinates of the target point and move autonomously or under remote control to the designated location.

### (c) Debris Detection and Trapping Step:

Upon arrival at the target point, the drones employ high-resolution cameras and infrared sensor modules to detect debris located on the surface and underwater, thereby identifying the position, size, and type of the debris. When debris is located within the target range, the drones deploy a net (230) via a net deployment device to trap the debris. The net is automatically adjusted according to the size and type of the debris. In one embodiment, metallic debris is trapped using a magnetic attachment, whereas plastic debris is stably collected using suction-based collection devices.

### (d) Hoisting Step:

When the debris is securely trapped in the net (230), the drones transport the net to a net hauling and lifting hook (110) mounted on the vessel. The net hauling and lifting hook (110), equipped with a sensor module, detects the position and status of the net and automatically initiates hoisting operations. The net hauling and lifting hook secures the net and retrieves the debris-filled net onto the vessel by means of a driving mechanism.

### (e) Onboard Processing Step:

The retrieved net is automatically transferred to a debris treatment area provided on the vessel. The net is opened via a closing and securing mechanism, and the collected debris is subjected to onboard processing.

The present invention provides the following advantageous effects:

### 1. Efficient Debris Collection:

The automated drone-based debris collection system enables faster and more efficient collection of debris compared with conventional manual methods. By utilizing the drone's autonomous navigation system, debris can be safely collected even in areas that are difficult for human access, and nets can effectively trap debris of various sizes and types.

### 2. Cost Reduction:

The invention reduces reliance on manpower and large-scale equipment, thereby significantly lowering operating costs compared with conventional methods. The automated drone system is capable of continuously performing debris collection operations, further decreasing labor and equipment maintenance expenses.

### 3. Environmental Protection:

The invention enables rapid removal of debris from marine and freshwater environments, thereby preventing water pollution and supporting the preservation of aquatic ecosystems. The autonomous debris collection system ensures that trapped debris is securely retrieved to the vessel, preventing its unintended release back into the water.

### 4. Enhanced Safety:

The use of drones substantially reduces the risk imposed on human operators. Remote or autonomous operations can be conducted in hazardous waters or environmentally sensitive areas, thereby minimizing the likelihood of human casualties.

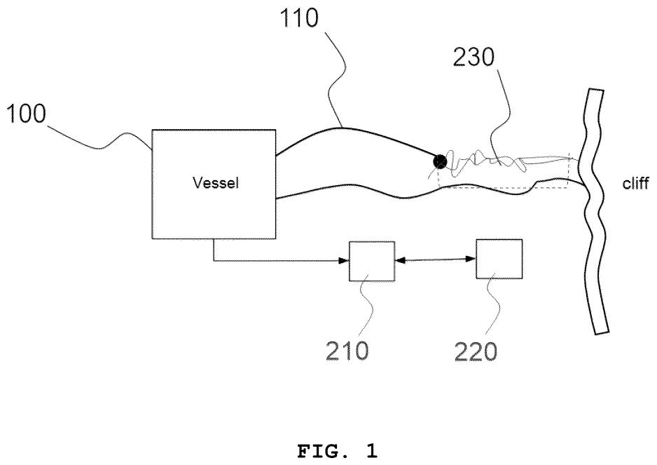

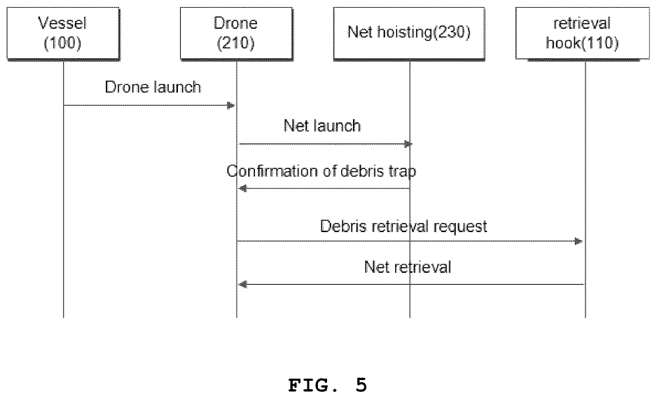

As shown in FIGS. 1 to 5, the present invention relates to a system for efficiently collecting debris in marine and freshwater environments using drones. The system comprises a vessel, drones, a net, and a net hoisting and retrieval hook, which cooperate to capture and retrieve debris onto the vessel. The following detailed description sets forth the functions and operations of each component to illustrate the effective operation of the system.

The vessel (100) constitutes the core component of the present invention, functioning as a control center for drone navigation, communication, battery charging, and debris retrieval. The vessel serves as a mobile platform adapted for marine and freshwater operations and plays a central role in the overall debris collection process.

The vessel is equipped with a drone launch and docking device that enables the drone to safely embark and disembark. The drone departs from the vessel to perform debris collection tasks and travels to designated target locations.

The vessel communicates with the drone in real time via a communication module, monitoring the drone's position, status, battery information, and debris collection progress. This module enables the vessel to remotely control the drones and allows operator intervention as needed, even during autonomous drone operation.

A power supply unit charges the drones' batteries upon their return to the vessel. As drones cannot operate for extended periods in marine and freshwater environments, efficient charging and battery management are essential. This enables the drones to repeatedly deploy and continuously perform debris collection operations.

The vessel further includes a debris processing zone where debris recovered by the drones is stored and sorted. This configuration ensures safe handling of debris from marine and freshwater environments and enables sorting and compression during processing.

The drones (210, 220) are unmanned aerial vehicles that travel from the vessel to target points (debris-concentrated areas) to detect and trap debris located on the surface or underwater in marine or freshwater environments. The drones are equipped with a GPS module, sensors, cameras, and a net deployment device, enabling them to perform debris collection tasks.

The drones autonomously travel to designated target points using a GPS and navigation system. This system tracks the drone's location in real time, calculates the optimal route, and ensures that the drones can travel efficiently while avoiding obstacles.

The drone's camera and sensor modules detect debris upon reaching the target location. The camera captures high-resolution images of marine or freshwater surfaces, enabling real-time assessment of debris location and condition. The sensor modules perceive the surrounding environment and precisely locate debris, transmitting control signals to the net deployment device. The drone is equipped with various sensors, including infrared, ultrasonic, and radar, to detect objects and dynamically adjust its navigation path.

The net deployment device, an essential component of the drone, mechanically deploys the net (230) at the target debris location using an electrical or mechanical drive. Upon deployment, the net captures the debris and automatically closes, securely retaining it to prevent escape.

The net (230), deployed by drones to capture debris at a target location, is designed as a modular structure that can be adjusted according to the size and type of debris. It is made from durable materials suitable for both marine and freshwater environments and features a specialized structure that enables efficient collection of various debris types.

The net may include one or more magnet attachment portions configured to attract and retain metallic debris. In environments with a high concentration of metallic waste, the magnets facilitate efficient debris capture without requiring additional maneuvering by the drone.

The attraction means is configured to effectively capture lightweight debris, such as plastic. Following deployment of the net, the attraction means draws the plastic debris into the interior of the net and retains it therein, thereby facilitating safe retrieval of the debris.

Once the debris is trapped, the automatic closing and locking mechanism of the net is activated, preventing the debris from escaping due to external environmental factors. After successful trap, the drone transports the net to the recovery point, where it is retrieved to the vessel by the net hauling and lifting hook.

The net hauling and lifting hook (110) functions to safely recover the net containing debris transported by the drone onto the vessel.

The net hoisting and retrieval hook, equipped with sensors and drive mechanism, is configured to automatically detect an approaching net, securely engage it, and retrieve the captured debris.

The net hauling and lifting hook includes a sensor module that detects the approaching net and automatically initiates the recovery process. The sensors analyze the net's position, weight, and condition to automatically control the hoisting operation, enabling recovery without the need for operator intervention.

The drive mechanism performs the operation of hoisting the net onto the vessel and, once the net is safely retrieved, transfers it to the vessel's debris processing zone. During this process, the drone does not consume additional energy for retrieval, and the hoisting hook enables rapid completion of the debris collection task.

The integrated control system serves as a central controller for managing all devices, including the vessel, drones, net, and hauling and lifting hook. The system analyzes data collected from each device to centrally control the entire debris collection operation and maximize operational efficiency. The real-time data processing unit analyzes drone trajectories, debris locations, and debris types, and controls the drones based on the analysis. Even during autonomous operation, the integrated control system monitors the drone status and provides an interface enabling operator intervention when necessary.

Furthermore, the autonomous control algorithm is configured to perform debris collection operations without operator intervention, thereby maximizing operational efficiency and reducing manpower requirements.

As shown in FIG. 6, the marine and freshwater debris collection system utilizing drones optimizes debris collection by assigning specific functions to each component.

The present invention is directed to a system in which the above components interact to provide more efficient debris collection.

The drones (210, 220) are equipped with a GPS and navigation system configured for autonomous movement toward target locations, enabling rapid and accurate travel to designated coordinates. The autonomous navigation system is a core function of the drones and is programmed to ensure safe movement to target points in marine or freshwater environments without manual control.

The GPS module determines the drones' real-time positions and calculates optimal routes to target points. The GPS data is transmitted to the vessel's integrated control system, which monitors the drones' positions and optimizes their travel paths.

The drones ensure safe travel through an obstacle avoidance system during autonomous movement. Cameras and sensor modules detect environmental factors, including wind, waves, and obstacles, in real time. Based on this information, the drones immediately modify their travel paths to avoid obstacles and safely reach the target location.

In particular, the drones' travel path programming accounts for environmental and weather conditions to ensure stable operation across various scenarios. The drones select routes less affected by wind and waves based on pre-programmed algorithms and continuously adjust their paths in real time using sensor data.

The real-time monitoring system aboard the vessel continuously monitors the drones' position and status. The communication module receives drone movement data, enabling real-time monitoring of status, battery level, and debris detection, and allowing manual intervention when necessary. This ensures stable drone operation during extended missions.

As illustrated in FIG. 6, the net (230) mounted on the drones is designed to effectively trap a wide variety of debris in marine and freshwater environments. The net is configured as a modular structure that can be adjusted based on the size and type of debris.

The mesh size of the net can be adjusted according on the size of the debris to be trapped.

For example, when collecting small plastic fragments or microplastics, the mesh size can be reduced to prevent escape of fine particles. For larger debris, the mesh size can be increased to enable faster and more efficient trapping. The mesh size adjustment can be performed manually or automatically controlled by the drone's autonomous control system.

The selection of net material is also an important factor. The net is fabricated from durable, corrosion-resistant materials, including synthetic fibers and non-corrosive metals suitable for marine environments. For collecting metallic debris, the net incorporates a magnetic attachment unit that effectively captures metal fragments and ferrous debris. The magnet is operatively connected to the drone's sensor, which detects metallic debris and automatically activates the magnet to guide and secure the debris within the net.

The attraction means is a component designed to effectively trap lightweight objects such as plastics and is installed inside the net. When the drone approaches plastic debris, the attraction means activates to draw the plastic debris into the net and secure it. This feature particularly assists in preventing lightweight debris from being pushed outside the net in areas with strong wave conditions.

The net's closing and locking mechanism is a device that automatically shuts the net after debris is trapped, ensuring the debris does not escape. Once the drone has trapped the debris, the net's closure device automatically operates to safely secure the debris. This feature ensures that the debris is not lost during transport or lifting. After capturing the debris, the net remains securely closed while the drone transports it back to the vessel.

As illustrated in FIG. 6, the net hoisting and retrieval hook (110) is a key device for retrieving the net containing the debris trapped by the drone back to the vessel. Installed on the vessel, the net hoisting and retrieval hook automatically detects and retrieves the net delivered by the drone. The sensor module is an essential component of the hauling and lifting hook and detects the net when the drone reaches the retrieval point, triggering the hauling and lifting hook to initiate the retrieval operation.

The sensor analyzes the net's position, weight, and condition in real time and controls the net hoisting and retrieval hook's drive mechanism to ensure rapid recovery of the net.

The net hoisting and retrieval hook performs the action of hoisting the net onto the vessel through its drive mechanism. The drive mechanism operates electrically or hydraulically, providing sufficient force to reliably retrieve the net. During this process, the net is securely transferred onto the vessel, and the drive mechanism is configured to prevent net damage and debris spillage.

The automatic retrieval system is programmed to perform the hoisting operation automatically when the drone approaches the vessel. Manual intervention by the operator is not required, as the net hoisting and retrieval hook automatically collects the net. During this process, the drive mechanism of the net hoisting and retrieval hook lifts the net into the designated position. The hoisting and retrieval hook is integrated with the vessel's central control system, enabling automatic retrieval each time the drone returns and minimizing potential errors during recovery.

The net retrieved by the hoisting and retrieval hook is securely transferred to the vessel's debris processing zone, which is configured for temporary storage, sorting, and processing of collected debris. A net release mechanism, operatively linked to the hoisting and retrieval hook, automatically opens the net once it is positioned inside the vessel, allowing the captured debris to be discharged into the debris processing zone.

The vessel's debris sorting and processing unit performs classification of debris based on material type, such as plastics, metals, and organics. Debris discharged from the net is automatically routed through the sorting system, where each type of debris is processed or stored appropriately. Upon completion of sorting, the debris is transferred to subsequent processing systems. In the case of plastic or metal debris, a compression device reduces volume to optimize storage space.

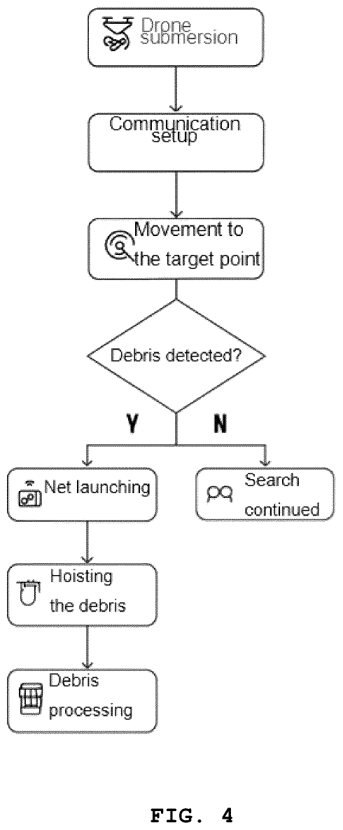

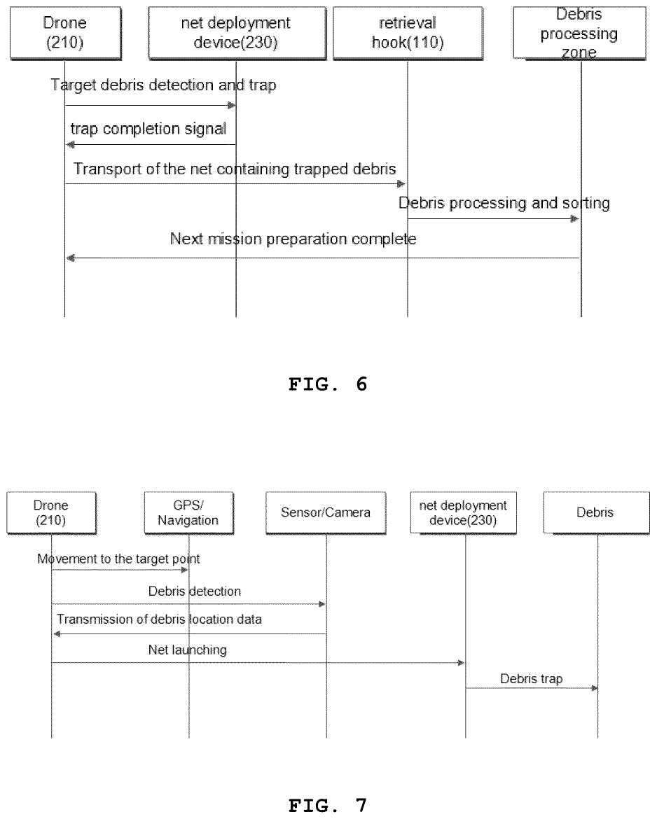

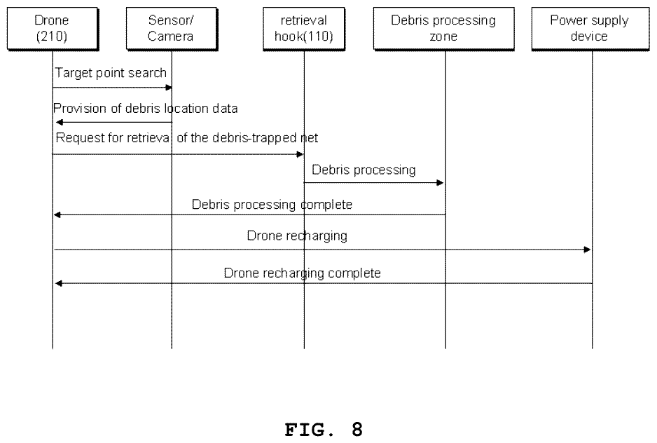

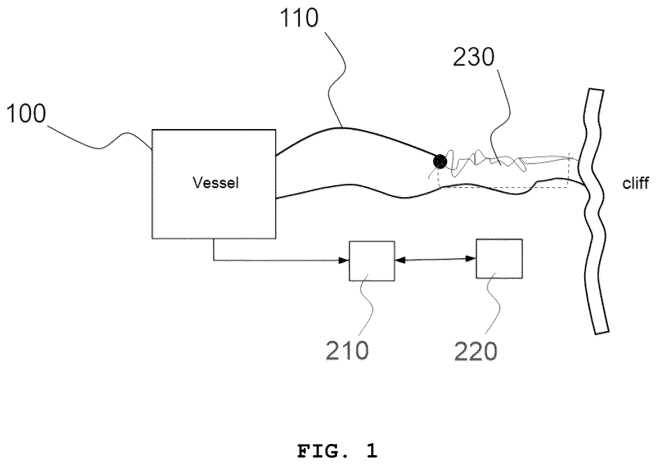

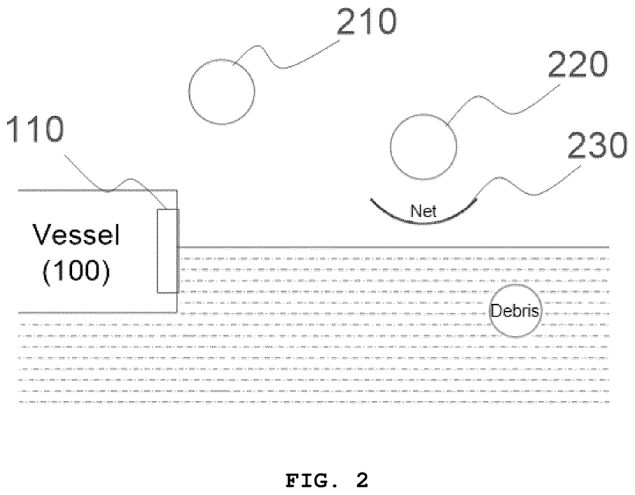

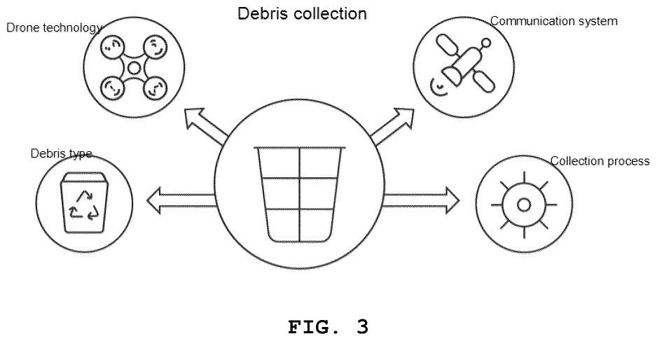

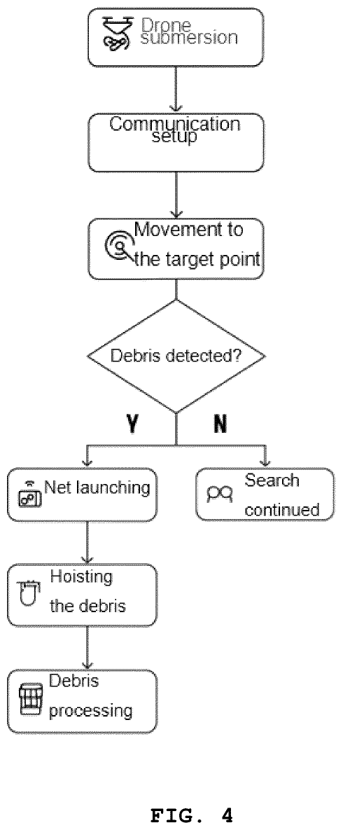

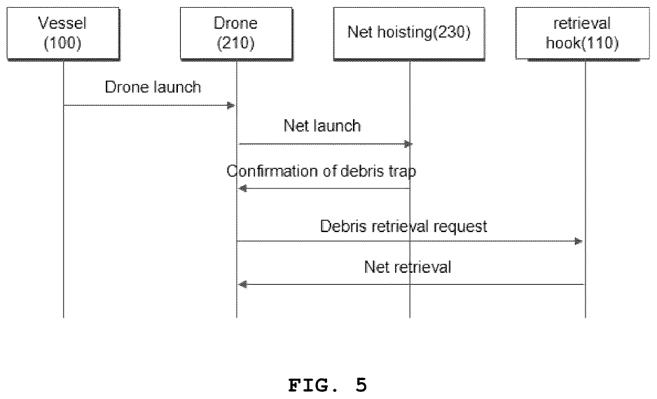

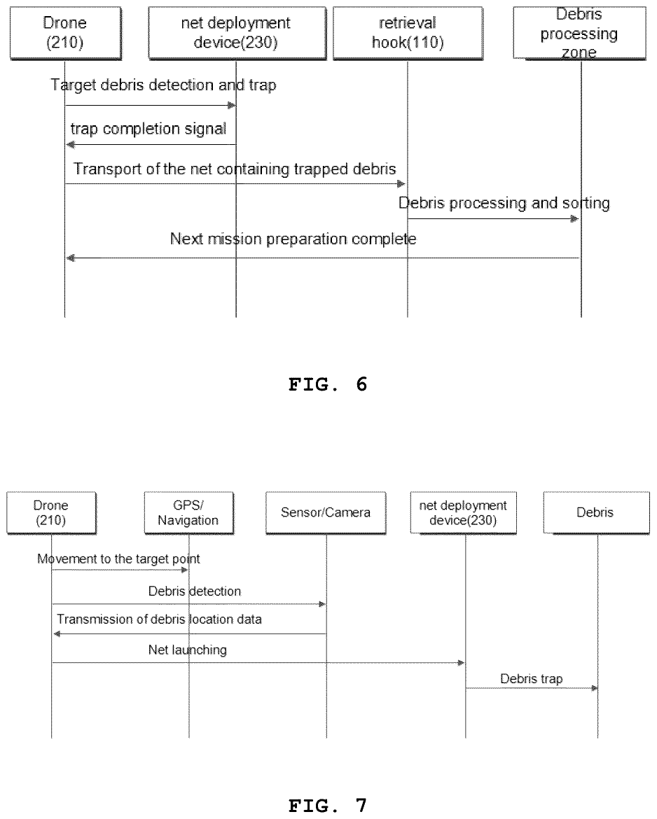

As shown in FIGS. 4 and 7, the present invention includes an autonomous debris collection method using drones to retrieve debris in marine and freshwater environments. The method comprises launching drones from a vessel, navigating them to a target location, capturing debris, and subsequently retrieving the drones back to the vessel.

Each step of the present invention enables efficient debris collection, and the following describes in detail the autonomous navigation, debris capture, net deployment, and retrieval processes.

1. The Step of Launching Drones (210, 220) from the Vessel (100)

The debris collection operation begins with launching drones (210, 220) from the vessel (100). The vessel, operating autonomously or via remote control in marine or freshwater environments, deploys the drones upon reaching a debris-concentrated area.

The drone launch and docking device provides a stable platform for drone launching and docking, ensuring stability against environmental factors such as wind and waves.

The communication module mounted on the vessel maintains real-time communication with the drone, continuously exchanging data after launch. Through this system, the vessel monitors the drone's location, battery level, and debris detection status in real time.

Immediately after launch, the drone autonomously navigates to the target point using GPS and navigation systems. Its movement follows predefined routes, with real-time data analysis enabling dynamic path adjustments.

### 2. The Step of Autonomously Navigating the Drone to a Target Location

After launch, the drone begins autonomous navigation to the target location via the GPS module. The drone follows a designated path based on target coordinates, adjusting its route as needed to avoid obstacles until it safely reaches the target location.

The onboard sensor module, equipped with ultrasonic sensors, infrared sensors, and radar, continuously monitors the surrounding environment in real time to prevent collisions and ensure an optimal navigation path.

The camera system captures high-resolution images in real time and is used for debris detection as the drone approaches the target location. It can identify debris floating both on the water surface and underwater, enabling precise localization of the debris to be trapped.

The drone's control system is configured to handle unexpected conditions during autonomous navigation by performing real-time data analysis and dynamic path correction. In the event of unforeseen obstacles or sudden environmental changes, the system automatically recalculates and establishes an updated route to ensure continued progress toward the target location. Upon arrival at the target location, the debris detection system is activated, and based on the position and condition of the detected debris, the system initiates preparation for net deployment.

### 3. The Step of Identifying Debris at the Target Location and Deploying the Net (230)

Upon arrival at the target location, the drone's sensor module and camera system precisely locate the debris. The debris identification algorithm analyzes the size, type, and position of the debris and determines the drone's optimal deployment position for net launch.

When the identified debris enters the trapping range, the net deployment device initiates deployment. The net (230) automatically adjusts its size and shape based on the debris type and dimensions, and is launched by the drone's net deployment device at the optimal timing.

The net deployment device operates via electrical or mechanical drive mechanisms, launching the net toward the debris. After deployment, the closure mechanism activates, securing the debris safely inside the net. During this process, the magnetic attachment unit or the attraction means may additionally activate, further assisting in the effective trap of metallic or plastic debris.

Once the net is successfully deployed and the debris is trapped, the drone monitors the debris entrapment status, transmitting updates on the debris' position and condition back to the vessel. When the debris is securely contained within the net, the drone prepares to move toward the net retrieval point.

4. The Step of Hoisting the Net (230) with Captured Debris onto the Vessel

Upon capturing debris, the drone determines the position of the vessel using the GPS system and establishes a return route. Concurrently, the route optimization system is activated to calculate the most efficient path, ensuring the drone's safe and rapid return to the vessel.

As the drone approaches the vessel, the net hoisting and retrieval hook (110) is activated to initiate the automatic recovery of the net carried by the drone. The net hoisting and retrieval hook comprises a sensor module configured to detect the position of the net and to automatically execute the recovery process.

The retrieval system is configured to minimize the energy consumption of the drone. While the net hoisting and retrieval hook raises the net, the drone remains in standby mode, without engaging in any additional movement. This system ensures the safe delivery of the net to the vessel and facilitates its automatic transfer to the onboard debris processing zone.

The net recovered by the net hoisting and retrieval hook is transported to the vessel's debris processing zone, where the debris is automatically sorted and processed. This process is fully automated, eliminating the need for manual operator intervention, and the sorting system is configured to process each type of debris appropriately.

### 5. The Step of Processing Retrieved Debris on the Vessel

The recovered debris is sorted and processed by the vessel's debris treatment system. The sorting system automatically classifies the recovered debris into categories such as plastics, metals, and organic matter, and directs each type to its corresponding processing zone.

The compression unit reduces the volume of plastic and metallic debris through compression, thereby enhancing the efficiency of storage and subsequent processing. Organic debris is directed to a dedicated storage area for further treatment. This process is governed by the vessel's automated control system, ensuring rapid and efficient classification and processing of debris. Specifically, debris collected from environmentally sensitive areas undergoes additional treatment procedures to minimize environmental impact.

### 6. The Step of Returning the Drone to the Vessel and Recharging the Drone's Power System

Upon completion of the debris trap and retrieval process, the drone automatically docks with the vessel's drone launch and docking device. The battery charging system then automatically recharges the drone in preparation for the next mission.

The power supply unit enables rapid charging, allowing the drone to be ready for the next debris collection task in a short time.

During this process, the drone's movement and debris collection data are transmitted to the vessel's integrated control system for analysis, optimizing future missions and providing performance feedback.

The integrated control system analyzes data from the drone, including debris location, size, and type, to automatically determine optimal navigation routes and task plans for subsequent collection missions.

As shown in FIGS. 4 and 8:

### 1. The Step of the Drone Autonomously Navigating to the Target Location is as Follows:

1.1 Launching the Drone from the Vessel and Setting the Autonomous Route

Before launching drones (210, 220), the vessel (100) sets the target location coordinates through its navigation system. These coordinates define the optimal route based on collected data and synchronize with the GPS, enabling the drones to autonomously follow the route.

The GPS system tracks the drones' position in real time and optimizes the route to the target location. An obstacle avoidance algorithm is activated during navigation, automatically adjusting the route when an obstacle is detected.

The drones' camera and sensor modules enable environmental recognition and analysis during autonomous navigation. Equipped with ultrasonic, infrared sensors, and radar, the system detects obstacles such as wind, waves, and objects in real time, ensuring safe and efficient drone navigation.

### 1.2 Monitoring and Control During Autonomous Navigation

While the drone navigates autonomously, the vessel's integrated control system continuously monitors its position, speed, and battery status. If the drone encounters unforeseen conditions or issues, the system analyzes the data in real time, reconfigures the route, or temporarily halts operations. In addition to GPS, the drone's navigation system uses visual navigation to enhance location accuracy as it approaches the target location. Visual navigation analyzes the surrounding environment using images captured by the drone's onboard camera, optimizing the path accordingly.

### 1.3 Debris Detection at the Target Location

Upon reaching the target location, the drone performs an environmental scan using its sensor module and imaging system to identify debris. The camera captures high-resolution images, while the sensors assess the size, shape, and position of the debris to determine the optimal capture path.

The drone is capable of detecting both surface and submerged debris, enabling the system to process a variety of debris types.

### 2. The Step of Drone Debris Capture and Return to the Vessel

This step relates to the method for safely returning the drone to the vessel after capturing debris. It involves the drone returning to the vessel and retrieving the captured debris to the vessel.

### 2.1 Process of Drone Debris Capture

After identifying debris at the target location, the drone deploys the net (230) to trap it. The net deployment mechanism propels the net toward the debris, and once it reaches the target point and entrap the debris, the net automatically closes.

The closing and locking mechanism prevents the debris from escaping. The magnetic attachment unit activates for metallic debris, drawing it into the net.

Once the debris is securely captured within the net, the drone verifies the vessel's position using the GPS navigation system and establishes the return route.

### 2.2 Route Optimization During Drone Return

Upon debris capture, the real-time route optimization system is activated for the drone's return journey. The system factors in weather conditions, wind direction, and wave intensity to compute the fastest and safest route.

Throughout the return, the sensor module continuously monitors the environment, triggering the obstacle avoidance system immediately upon detection of any obstacles. This ensures the drone carrying captured debris returns safely to the vessel.

### 2.3 Preparation for Debris Retrieval

As the drone approaches the vessel, the net hoisting and retrieval hook (110) is activated, preparing to automatically recover the net carried by the drone. The sensor module of the net hoisting and retrieval hook detects the positions of both the drone and the net, triggering the drive mechanism to haul the net onto the vessel.

The integrated control system ensures continuous communication between the drone and the net hoisting and retrieval hook, maintaining precise alignment for efficient net recovery. While the net hoisting and retrieval hook performs the recovery operation, the drone halts its return movement and remains in standby mode.

### 3. The Step of Processing Retrieved Debris on the Vessel

### 3.1 Debris Sorting and Automatic Processing System

The net recovered by the net hoisting and retrieval hook (110) is transferred to the vessel's debris processing zone, where the debris is automatically sorted and processed. The sorting system classifies the debris into plastics, metals, and organic matter, transferring each type to the appropriate subsequent process.

Plastic debris is transferred to a designated storage space and compressed to reduce volume. Compressed plastics are stored efficiently and prepared for later processing.

Metallic debris captured by the magnetic attachment unit is further classified based on recyclability in the sorting system.

Organic debris is stored in a designated compartment for subsequent treatment, with emphasis placed on quickly removing and processing debris harmful to the marine ecosystem.

### 3.2 Debris Treatment and Recycling

In the debris processing zone, sorted debris undergoes processing using appropriate methods to ensure safe handling. The processed debris is either recycled into reusable materials or properly disposed of to prevent marine pollution.

The sorting system autonomously categorizes the debris to prioritize the prompt processing of harmful materials, thereby minimizing the environmental impact following the collection.

### 3.3 Drone Recharging and Preparation for the Next Mission

After delivering the collected debris to the vessel, the drone is recharged by a power supply system. The power supply system supports rapid charging, thereby enabling the drone to resume operation within a short time.

In addition, operational data acquired by the drone during debris collection is transmitted to an integrated control system on the vessel, where the data is stored and subjected to analysis. The analysis results are utilized to establish optimal navigation routes and work schedules for subsequent missions.

Accordingly, the debris collection method of the present invention, implemented by drones, provides a system that autonomously performs navigation, debris capture, retrieval, and debris processing, thereby enabling rapid and efficient removal of marine and freshwater debris. Each operational stage is configured to maximize efficiency while minimizing operator intervention through autonomous control and automated workflows.

The specific configuration of the drone launch and docking device and platform design of FIG. 1, as well as the required programs, are as follows.

The drone launch and docking device and platform include a mechanical structure for launching and docking the drone, a wireless communication module for communication between the drone and the vessel, a power supply unit for recharging the drone batteries, and an integrated control system for monitoring and controlling drone operations.

Operation of these components requires dedicated software programs. The drone control software governs launch, docking, and route planning. The communication protocol software manages data exchange between the drone and the vessel. The power management software monitors and controls battery charging, while the integrated control system software supervises overall system operation and monitoring.

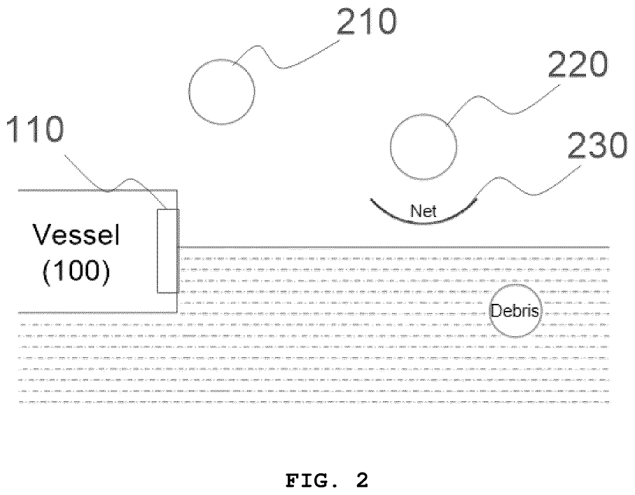

The net deployment device and the debris collection method illustrated in FIG. 2 may be embodied as follows.

The net deployment mechanism may be spring-based or pneumatic, propelling the net using elastic force or compressed air. The net itself may be modular in structure, allowing adjustment of mesh size and material according to the type and size of debris, by employing interchangeable modules and adjustable frames.

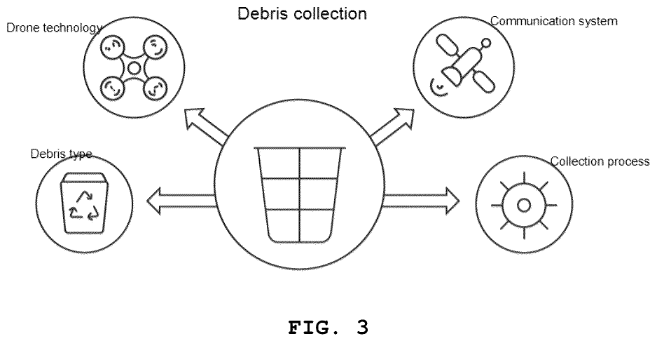

For capturing metallic debris, a magnetic attachment unit comprising strong electromagnets is provided at the edge of the net and is activated upon detection of metallic debris. For capturing plastic debris, the interior of the net may be coated with a fine adsorptive material, and a static electricity generator may be employed to attract and retain plastic particles. Referring to FIGS. 2 and 3, a net hauling and lifting unit installed on the vessel for recovering a net deployed by the drone includes a sensor module configured to detect debris-laden nets and automatically lift them, and a hauling and lifting hook (110) configured to secure the net and ensure its safe transfer to the vessel. The unit is further designed to hold and recover the net firmly as follows.

To ensure stable net fixation, the system employs automatic locking hooks, multi-point attachment, and tension adjustment devices to maintain a secure connection and proper load distribution. The recovery mechanism includes an electric winch, stabilizing guides, and shock-absorbing devices to enable stable hoisting and minimize impact during retrieval. These operations are automated via sensor-based control, including weight sensors, position tracking sensors, and tension monitors.

The debris collection system of the present invention further comprises an integrated control system. The integrated control system functions as a central control unit for the vessel, drones, nets, and hauling and lifting hooks, and includes a real-time data processing unit configured to analyze data collected from each component. The system is capable of controlling debris detection, drone navigation, net deployment, and lifting operations. Through an interface module installed on the vessel, an operator may manually control the system if necessary. The integrated control system is programmed with autonomous control algorithms, including machine learning and reinforcement learning, to enable seamless operation of all tasks without operator intervention. The autonomous control algorithms include the following functions.

Through machine learning-based decision making, the system analyzes past debris collection data to derive optimal operational strategies, recognize debris distribution patterns, and predict situational developments, thereby enabling efficient operations. By applying reinforcement learning, the system improves algorithm performance through rewards for successful debris collection and enhances real-time responsiveness to new situations encountered during operation. The autonomous control functions include automatic generation of optimal paths considering debris and vessel positions, obstacle avoidance and route adjustment based on real-time sensor data, and task sequence optimization for efficient collection of multiple debris items.

The present invention comprises the following steps.

A step of launching drones (210, 220) from the vessel (100), wherein, after the vessel (100) arrives near the target location, the vessel's drone launch and docking device launches the drones (210, 220), initiating communication between the vessel-mounted communication module and the drones for transmitting information on their navigation paths and the target location, and the drones (210, 220) then proceed toward the target location via the vessel's remote control or autonomous navigation mode.

A step of navigating drones (210, 220) to the target location, wherein the drones utilize an onboard GPS and navigation system to determine the coordinates of the target location and proceed thereto either autonomously or under remote control.

A step of detecting debris at the target location and deploying a net (230) to collect the debris, wherein, upon reaching the target location, the drones detect surface or underwater debris using high-resolution cameras and infrared sensors, determine debris position and size, and if the debris is within the capture range, deploy the net (230) to trap it. The net automatically adjusts to debris size and type, with magnets for metallic debris and the attraction means for plastics.

A step of recovering the net (230) containing debris by drawing it to the vessel and hoisting it on board, wherein once the debris is securely captured in the net (230), the drone delivers the net to the hoisting and retrieving hook (110) which is guided by a sensor module on the vessel, detects the position and status of the net, engages the net, and via a drive mechanism draws the net toward the vessel and hoists it on board.

A step of transferring the net to the debris processing zone, wherein the net is opened by a closure and locking mechanism to discharge the retrieved debris.

The closure and locking mechanism is configured as follows.

The automatic closure system comprises a circular frame surrounding the net entrance, shape-memory alloy wires that contract in response to electrical signals, and a trigger mechanism for transmitting a closure signal upon detection of debris capture. The locking mechanism comprises an automatic lock for the closed entrance, a multi-point fixation system to simultaneously secure multiple points of the net, and a tension adjustment device to maintain appropriate net tension.

Closure and locking are controlled through pressure sensors detecting changes in internal pressure, weight sensors measuring load variations, and optical sensors verifying debris presence inside the net.

A step in which the drones (210, 220) navigate to the target location, wherein during navigation, the drones detect the surrounding environment via sensor modules to avoid obstacles and calculate optimal routes, while simultaneously searching for debris presence at the target location and transmitting this information to the vessel in real time.

In this step, the drones' obstacle avoidance and optimal route calculation are carried out by the following methods.

Obstacle detection is performed by three methods: 3D mapping of the surrounding environment using LiDAR based on laser technology, ultrasonic sensors for close-range obstacle detection and distance measurement, and real-time image analysis through optical cameras for obstacle identification. Collected sensor data is processed using SLAM (Simultaneous Localization and Mapping) to generate a real-time map of the environment, while object recognition algorithms and distance calculations determine the position and distance of obstacles.

For optimal path planning, the A* algorithm is used to calculate the shortest path from the start point to the target location, including a dynamic path planning function that recalculates the route in real time upon obstacle detection. Additionally, an energy-efficient route selection algorithm is applied to minimize battery consumption.

The step of processing the retrieved debris on the vessel comprises securely loading the debris onto the vessel, during which the debris is sorted or compressed according to its type. A sorting unit installed on the vessel automatically classifies the debris into plastics, metals, and organic materials using an optical sorter and magnets, and the retrieved debris is then compressed by the vessel's onboard processing system.

The method for safely loading the retrieved debris onto the vessel is as follows.

To ensure the safe transfer of captured debris onto the vessel, shock absorbers are installed between the net and the vessel, a stabilization guide prevents net instability during hoisting, and automatic speed control systems regulate the transfer process.

Inside the vessel, conveyor belts, slope adjusters, and sealed transfer channels securely transport the debris to the debris processing zone. The debris is then automatically sorted and directed to designated storage areas. An automated compression system reduces its volume, and the debris is securely stored in sealed containers.

After completing debris retrieval, the drone automatically docks with the vessel's launch and docking device and begins recharging via the onboard power supply system. During preparation for the next mission, the drone transmits navigation and retrieval data to the integrated control system for analysis and recordkeeping.

The analysis and recordkeeping of debris retrieval data are performed as follows.

Data collected includes environmental information from various sensors mounted on the drone, task-related information such as debris capture time, location, and quantity, as well as footage of the operation site recorded by the drone's onboard camera.

The collected data is transmitted to the vessel in real time via 5G or satellite communication, with compression and encryption applied to ensure transmission efficiency and data security.

The integrated control system analyzes the extensive data set using big data analytics and machine learning algorithms. The analysis encompasses debris distribution prediction, optimal route planning, and evaluation of performance metrics such as operational efficiency and energy consumption. The analyzed data is systematically stored in a database, which serves as the basis for generating automated reports. Intuitive data visualization through graphs and charts enables easy monitoring of operational status. This process continuously improves debris retrieval efficiency and accumulates critical data for aquatic environmental protection.

### EXPLANATION OF REFERENCE NUMERALS

100: Vessel
110: Net hoisting and retrieval hook
210, 220: Drone
230: Net

1. A marine and freshwater debris collection system using drones, comprising:
a vessel (100), which includes a drone launch and docking device and provides a platform designed for launching and recovering drones, is equipped with a communication module to enable real-time communication with the drones, further includes a power supply device to charge the drones' batteries, and is a vehicle capable of remote-controlled or autonomous navigation to target marine or freshwater locations;
at least one drone (210, 220), which is launched from the vessel, is equipped with a camera and sensor module to detect the position of debris at the target point, includes GPS and a navigation system to support autonomous movement, is configured to detect and avoid obstacles or follow specific paths based on sensor data including LiDAR and ultrasonic sensors for obstacle avoidance, and is designed to detect and trap debris located on the surface or underwater in marine and freshwater environments; and
a net deployment device comprising a mechanical or electrical drive mechanism that enables the drone to launch a net (230) at the target debris location.

2. The marine and freshwater debris collection system using drones of claim 1,
wherein the net deployment device is configured to deploy the net by the drone to trap debris at a target point,
wherein the net deployment device comprises a spring-based or pneumatic launching mechanism configured to deploy the net toward the target point, and a modular structure allowing adjustment of mesh size and material according to the size and type of debris,
wherein the net further comprises a magnetic attachment unit for capturing metallic debris and an attraction means for collecting plastic debris, and wherein, after deployment, when debris is trapped, an automatic closure and locking mechanism is activated to prevent escape of the debris.

3. The marine and freshwater debris collection system using drones of claim 1,
further comprising a ring-shaped net hoisting and retrieval hook (110) configured to recover the net deployed by the drone, securely hold the net, and retrieve it to the vessel for safe delivery of the captured debris.

4. The marine and freshwater debris collection system using drones of any one of claim 1,
further comprising an integrated control system configured as a central control unit for operating the vessel, the drones, the net, and the net hoisting and retrieval hook, the system including a real-time data processing unit configured to analyze data collected from each device and to control debris detection, drone route adjustment, net deployment, and retrieval operations.

5. A method for collecting debris from marine and freshwater environments using drones, comprising:
a step in which drones (210, 220) depart from the vessel, wherein the vessel (100), after arriving near a target point, launches the drones (210, 220), initiates communication between the vessel's communication module and the drones, transmits information regarding the drones' movement paths and the target point, to move the drones (210, 220) from the vessel's docking device toward a designated area through remote-control or autonomous movement mode;
a step in which the drones (210, 220) move to the target point, wherein the coordinates of the target point are set by the GPS and navigation systems mounted on the drones, and the drones move autonomously or via remote control according to the set coordinates;
a step of detecting debris at the target point, and launching and retrieving the net (230), wherein, upon the drones' arrival at the target point, the drones detect debris located on the surface or underwater of marine or freshwater environments using high-resolution cameras and infrared sensor modules, determine the position and size of the detected debris, and, if the debris is within the target range, deploy the net (230) using the drones' net deployment device to trap the debris, with the net being automatically adjusted according to the size and type of the debris, wherein metallic debris is trapped using a magnetic attachment unit and plastic debris is collected using an attraction means;
a step of retrieving the net (230) containing the trapped debris onto the vessel and transferring the debris into the vessel, wherein, after the debris is safely trapped in the net (230), the drone moves the net toward the net hoisting and retrieval hook (110), which, using a sensor module installed on the vessel, detects the position and state of the net, automatically initiates retrieval, secures the net, and hoists it onto the vessel via a driving mechanism;
a step in which the hoisted net is automatically transferred to the vessel's debris processing zone, where the closure and locking mechanism opens the net, and the retrieved debris is processed on the vessel.

6. The method for collecting debris from marine and freshwater environments using drones of claim 5,
wherein the step of navigating the drones (210, 220) to the target location includes detecting the surrounding environment with the drones' sensor modules during navigation to avoid obstacles or calculate specific routes, while searching for the debris at the target location and transmitting the information to the vessel in real time.

7. The method for collecting debris from marine and freshwater environments using drones of claim 5,
wherein the step of processing the retrieved debris on the vessel includes automatically sorting the debris by type using a sorting unit equipped with an optical sorter and a magnet for classifying plastic, metal, and organic matter, followed by compressing the sorted debris using the vessel's onboard processing system.

8. The method for collecting debris from marine and freshwater environments using drones of claim 5,
further comprising a step of drone returning and recharging, wherein, after completing the debris trapping operation, the drones return to the vessel's launch and docking device, automatically couple to the docking device, and are recharged via the vessel's power supply system, while their navigation data and debris collection information are transmitted to the vessel's integrated control system for analysis and recordkeeping, in preparation for the next mission.

9. The marine and freshwater debris collection system using drones of claim 2,
further comprising an integrated control system configured as a central control unit for operating the vessel, the drones, the net, and the net hoisting and retrieval hook, the system including a real-time data processing unit configured to analyze data collected from each device and to control debris detection, drone route adjustment, net deployment, and retrieval operations.

10. The marine and freshwater debris collection system using drones of claim 3,
further comprising an integrated control system configured as a central control unit for operating the vessel, the drones, the net, and the net hoisting and retrieval hook, the system including a real-time data processing unit configured to analyze data collected from each device and to control debris detection, drone route adjustment, net deployment, and retrieval operations.
